(19) United States
(12) Patent Application Publication
(10) Pub. No.: US 2010/0258089 A1
(43) Pub. Date: Oct. 14, 2010

(54) Method for Operating an Injection System

(76) Inventor: Metin Gencbay, Gerlingen (DE)

Correspondence Address: KENYON & KENYON LLP, ONE BROADWAY, NEW YORK, NY, 10004, US

(21) Appl. No.: 12/226,589

(22) PCT Filed: Mar. 27, 2007
(86) PCT No.: PCT/EP2007/052911

§ 371 Date: Jun. 21, 2010

(30) Foreign Application Priority Data
Apr. 24, 2006 (DE) 10 2006 018 957.4

(51) Int. Cl. F02M 51/00

(52) U.S. Cl. 123/494

(57) ABSTRACT

A method for operating an injection system, in particular an injection system of an internal combustion engine having piezoelectrically triggered injectors, in which a basic voltage is applied to the injectors in the closed state, and a bottom voltage is applied to open them. The bottom voltage is individually adjusted for each injector.

### FIELD OF THE INVENTION

The present invention relates to a method and to a control device for operating an injection system, in particular an injection system of an internal combustion engine, having piezo-electrically triggered fuel injectors, in which a basic voltage is applied to the fuel injectors in the closed state, and a bottom voltage is applied to open them.

### BACKGROUND INFORMATION

Generic injection systems are referred to as common rail injection systems and used both in Otto and in diesel combustion engines. The injection system usually includes one piezoelectric fuel injector per cylinder of the internal combustion engine.

In particular in stratified operation of an Otto combustion engine, what is generally known as micro-quantities in the range of approximately 1 mm³ are injected during each injection. It has become apparent that the deviations of the injection quantity between the piezoelectric injectors of the cylinders are so considerable that they manifest themselves in a reduced exhaust-gas quality and in lower driving comfort as a result of greater irregular running.

Therefore, it is an object of the present invention to provide a method and a control device for implementing the method, which reduce the deviations of the injection quantities among different piezoelectric injectors.

### SUMMARY OF THE INVENTION

This problem is solved by a method for operating an injection system, in particular an injection system of an internal combustion engine, having piezo-electrically triggered injectors, in which a basic voltage is applied to the injectors in the closed state, and a bottom voltage is applied to open them, the bottom voltage being individually adjusted for each injector. The bottom voltage is a voltage value which is lower than the basic voltage, to which value the voltage applied to a piezo element of the piezoelectric injector is intermittently lowered so as to achieve micro quantities in the injection.

It is preferably provided that the bottom voltage for each injector is determined from an average value of the bottom voltage and an individual correction value for the injector. The average value of the bottom voltage (average value across a plurality of piezoelectric injectors of an internal combustion engine) may be determined from, e.g., a setpoint injection quantity and an associated average bottom voltage stored in a control device. In this context the average bottom voltage may be ascertained in a test over a large number of piezoelectric injectors, for example, and stored in the control device as type-specific value.

It is preferably provided that the correction value includes a correction factor, the bottom voltage for each injector being determined from the average value of the bottom voltage multiplied by the correction factor. As an alternative or in addition, the correction value may include an offset, and the bottom voltage for each injector is determined from the average value of the bottom voltage to which the offset is added.

The correction value may be specific to an operating point, i.e., different correction values (correction factor or offset) may be stored in the control device for different average values of the bottom voltage (and thus different setpoint injection quantities).

The problem mentioned in the introduction is also solved by a computer program having program code to implement all of the steps according to a method of the present invention when the program is executed on a computer, and also by a control device for operating an injection system, in particular an injection system of an internal combustion engine, having piezo-electrically triggered injectors, in which a basic voltage is applied to the injectors in the closed state, and a bottom voltage is applied to open them, wherein the bottom voltage is individually adjusted for each injector.

### BRIEF DESCRIPTION OF THE DRAWINGS

FIG. 1 shows a sketch of a voltage characteristic over time at a piezoelectric injector.

FIG. 2 shows a sketch of the injection quantity over the bottom voltage for a plurality of piezoelectric injectors.

FIG. 3 shows a flow chart of the method.

### DETAILED DESCRIPTION

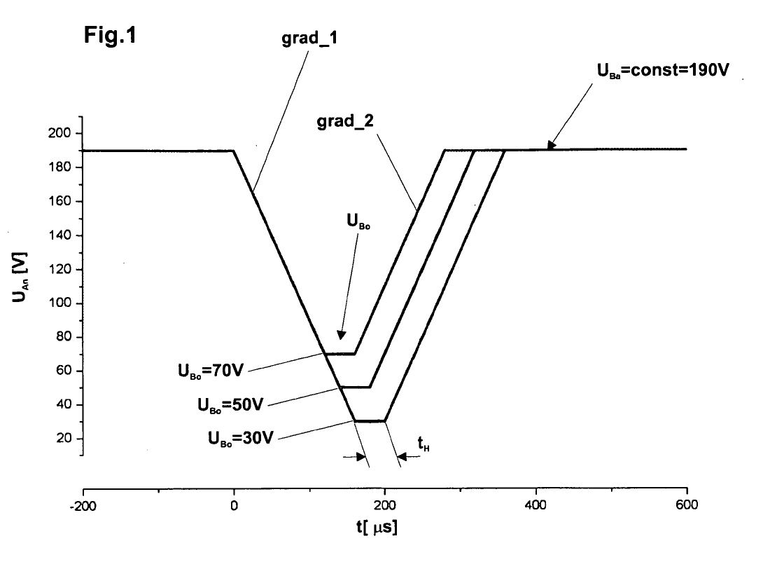

FIG. 1 shows trigger voltage U_{An} of a piezoelectric injector over time t. Trigger voltage U_{An} is specified in Volt, time t has been plotted in microseconds μs. Trigger voltage U_{An} is the voltage applied at the piezo element. A piezoelectric injector (piezo injector) having a direct needle is assumed here, i.e., a piezoelectric injector in which the valve needle is directly set in motion by a piezoelectric actuator. In the direct needle control, the nozzle needle is actively triggered and moved by a direct actuating element. The actuating element is a piezoelectric actuator, which directly controls the nozzle needle via a hydraulic coupler.

FIG. 1 shows the triggering of such a piezoelectric injector for the purpose of achieving what is referred to as micro-quantities. Micro-quantities are injected, e.g., in the pre-injection of an Otto engine in stratified-charge operation. The injection process is induced by lowering a constant basic voltage U_{Ba} of, for example, 190 Volt, to what is generally known as bottom voltage U_{Bo}. The injection quantity is a function of the difference between basic voltage U_{Ba} and bottom voltage U_{Bo}. Bottom voltage U_{Bo} is kept constant for a holding period t_{H}, and raised again to basic voltage U_{Ba} once the holding period, which amounts to a constant 38 μs in the present example of FIG. 1, has elapsed. FIG. 1 shows three exemplary voltage characteristics having different bottom voltages U_{Bo} of 30 Volt, 50 Volt and 70 Volt, respectively. Voltage gradient ΔU/Δt when lowering the voltage from basic voltage U_{Ba} to bottom voltage U_{Bo} (grad_1) and also voltage gradient ΔU/Δt when increasing the voltage from bottom voltage U_{Bo} to basic voltage U_{Ba} (grad_2) are mainly specified by the capacitance of the piezo elements and the displacement current of a driver stage for controlling the piezo elements and may thus assume different values. The injection quantity to achieve micro-quantities is thus realized solely via the control of bottom voltage U_{Bo}, i.e., basic voltage U_{Ba} is kept constant, and the quantity is adjusted only by varying bottom voltage U_{Bo}. The sum of the falling edge from basic voltage U_{Ba} to bottom voltage U_{Bo} as well as holding period t_{H}, and the rising edge from bottom voltage U_{Bo} to basic voltage U_{Ba}, is kept to a minimum. The voltage differential between basic voltage U_{Ba} and bottom voltage U_{Bo} becomes smaller due to the increase in bottom voltage U_{Bo}, the entire control period, i.e., the time from the start of the reduction of basic voltage U_{Ba} to bottom voltage U_{Bo} and the reattainment of basic voltage U_{Ba} starting from bottom voltage U_{Bo}, is reduced, which leads to a decrease in the injection quantity. Bottom voltage U_{Bo} may be increased until the pre-injection is omitted completely, i.e., the injection quantity becomes equal to zero. Given a constant basic voltage U_{Ba}, constant holding period t_{H}, and constant voltage gradients when lowering the voltage or when increasing the voltage, the injection quantity is therefore solely a function of bottom voltage U_{Bo}. That is to say, the injection quantity for an injector is representable as being a function of a single variable—bottom voltage U_{Bo}.

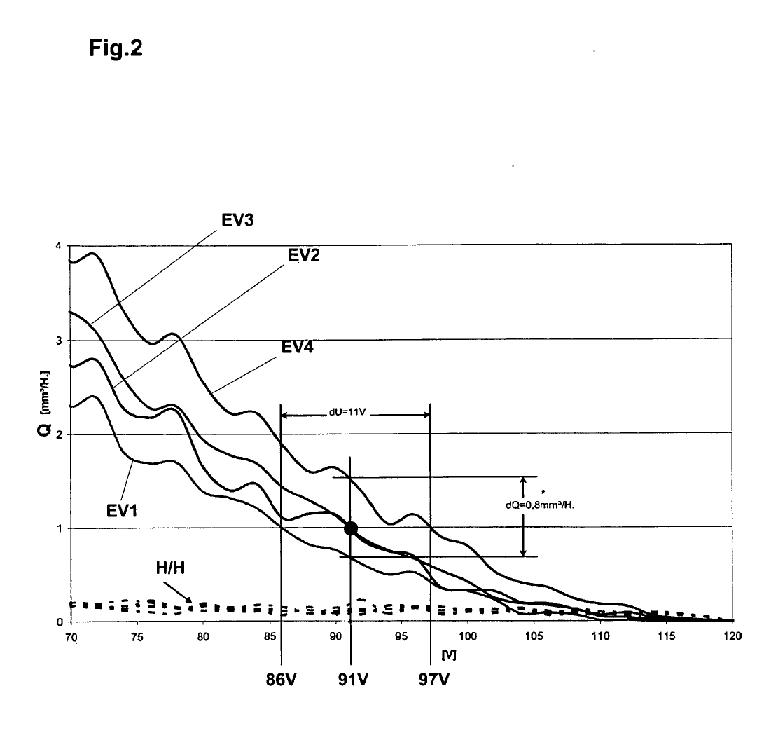

In FIG. 2, injection quantity Q has been plotted in cubic millimeters per injection process mm³/H (here, the injection process is abbreviated by H as in Hub (lift)) over bottom voltage U_{Bo} in Volt for a plurality of injectors, which are denoted by EV1 through EV4. To this end, four identical type PDN25B injectors were operated at different bottom voltages U_{Bo} with a constant basic voltage of U_{Ba} amounting to 190 Volt, and the individually achieved injection quantity Q was measured in cubic millimeters for each injection process H. The bottom voltage was increased in two-Volt increments. With each increment, fifty injection quantities Q were measured for each injection process. From this, a lift/lift deviation was determined for each piezoelectric injection valve (also referred to as injector), for one, and deviations Ex/Ex among the individual piezoelectric injectors were determined for another. The curves of the lift/lift deviations are shown in the lower region of FIG. 2 and denoted by H/H, and the Ex/Ex deviations can be found in the curves above, which are denoted by EV1 through EV4. On the one hand, it can be gathered from the illustration of FIG. 2 that the injection quantity decreases with increasing bottom voltage U_{Bo}; on the other hand, a relatively high deviation is noticeable among the examined injectors. The lift/lift deviations are relatively low, so that their effects may be disregarded. However, the curves of injection quantity Q over bottom voltage U_{Bo} of the same-type piezoelectric injectors used in the testing, which are denoted by EV1 through EV4, are considerably higher. In the example of FIG. 2, to inject a quantity of one cubic millimeter per injection, piezoelectric fuel injector 1 requires a bottom voltage U_{Bo} of 86 V, whereas piezoelectric fuel injector 4 requires a bottom voltage U_{Bo} of 97 V for the same injection quantity. The two other piezoelectric injectors 2, 3 require a voltage of approximately 91 V for this purpose. Voltage range dU for achieving identical injection quantities of the injectors thus amounts to 11 V in this case. If all piezoelectric injectors 1 through 4 in an internal combustion engine are operated at the same averaged bottom voltage U_{Bo} of 91 V, then this results in a deviation of the injection quantity for the four piezoelectric fuel injectors of 0.8 mm³/H. At the bottom voltage of 91 V, piezoelectric injector 1 produces an injection quantity of approximately 0.8 mm³/H; at a bottom voltage U_{Bo} of 91 V, piezoelectric injector 4 produces an injection quantity of approximately 1.6 mm³/H. Such differences in the pre-injection quantity in different cylinders increase the emissions. In order to then equalize the piezoelectric injectors for the micro-quantities on the side of the control device, bottom voltages U_{Bo} of the different injectors are corrected in an injector-specific manner. The correction is induced via a factor K_{Bo} or an offset C_{Bo}. In the selected exemplary operating point having a setpoint injection quantity (desired injection quantity) Q of 1 mm³/H and a rail pressure of 800 bar, bottom voltage U_{Bo}_{_{—}}_{M} averaged over the four piezoelectric injectors amounts to 91 V. As can be inferred directly from FIG. 2, the bottom voltage for piezoelectric injector 1 at a setpoint injection quantity Q of one cubic millimeter per injection amounts to 87 V, so that a factor of 0.9451 is applied to the average value of bottom voltage U_{Bo}_{_{—}}_{M} in order to arrive at required bottom voltage U_{Bo} of 87 V. This corresponds to an offset C_{Bo} with respect to the averaged bottom voltage of −5 V. In the example of FIG. 2, piezoelectric injector 4 requires a higher bottom voltage U_{Bo} in order to realize 1 mm³/H and a factor >1 must therefore be applied. In general, the factor is calculated in the following way:

K_{Bo}=U_required/U_average

U_required denotes the bottom voltage at each piezoelectric injector that is required in order to achieve the setpoint injection quantity. U_average denotes the bottom voltage, averaged across all piezoelectric injectors, required so as to achieve the setpoint injection quantity. In the example from FIG. 2, bottom voltage U_{Bo}_{_{—}}₄ required for the piezoelectric injector for an injection quantity of 1 mm³/H amounts to 97 V, U_required=97 V. The averaged bottom voltage U_average amounts to 91 V, from which a correction factor K_{Bo}_{_{—}}₄ of 1.066 results for piezoelectric injector 4. The offset voltage for piezoelectric injector 4 is 6 V. If this injector-specific correction is then applied, the injectors are equalized on the side of the control device, which results in a reduction of the Ex/Ex deviations of the pre-injection quantity.

The determination of correction factors K_{Bo} or voltage offsets C_{Bo} explained on the basis of the example of a setpoint injection quantity Q of one cubic millimeter per injection, must be implemented separately for each individual operating point. To this end, the operating points in a range of injection quantities per injection that is used for micro-quantities and thus may be utilized for an equalization, could be examined in a stepwise manner, for instance. In a range of the setpoint injection quantity between 0.4 cubic millimeter per injection and 3 cubic millimeter per injection, for example, with steps of 0.1 cubic millimeter per injection, correction values for the individual injectors could be determined. The correction values are then stored in a control device in the form of a table of a characteristic map, for example.

As an alternative, it is possible to determine a constant correction value across the entire range. To this end, an average correction value may be ascertained, which is determined from correction values across a range as previously explained, or it is possible to use a correction value at a single working point, as explained with the aid of FIG. 2, for example, for the entire range. In this case, instead of a table having a plurality of values specific to operating points, a single value may be used for each piezoelectric injector.

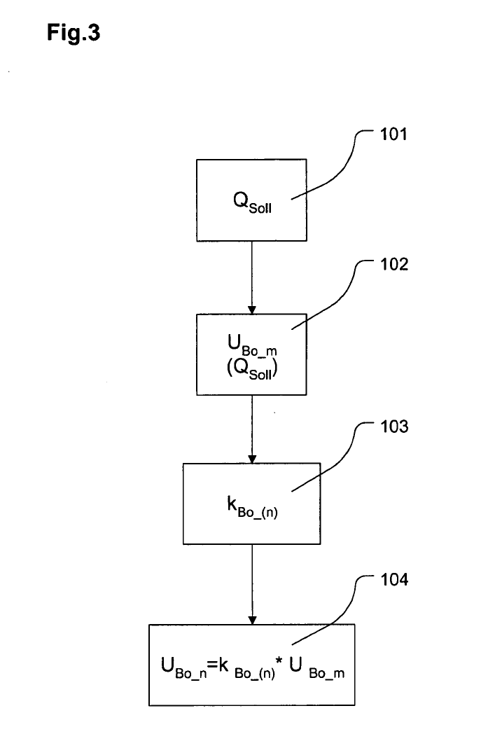

FIG. 3 shows a flow chart of an associated working process. In a step 101, a setpoint injection quantity Qₛₑₜₚₒᵢₙₜ is first determined for each injection process. This value may be provided by a control device of an internal combustion engine in a manner specific to an operating point, for instance. Then, in a step 102, average value U_{Bo}_{_{—}}_{M} is determined for the average bottom voltage of all piezoelectric injectors. The average value may be stored as an average setpoint value for a model line of a piezoelectric injector, which represents the average value across a large number of identical piezoelectric injectors. An individual correction factor K_{Bo} is then determined for each piezoelectric injector in step 103. The index (n) here is meant to illustrate that this value is determined individually for every piezoelectric injector. The values may be taken from, e.g., a table, which is stored in a memory. In step 104, the value of the bottom voltage for each piezoelectric injector n is then determined as the product from injector-specific factor K_{Bo}_{_{—}}₍ₙ₎ and average bottom voltage U_{Bo}_{_{—}}_{M}. Instead of factors K_{Bo}_{_{—}}₍ₙ₎, it is also possible here to determine offsets C_{Bo} in an analogous manner.

1-7. (canceled)

8. A method for operating an injection system of an internal combustion engine having piezoelectrically triggered injectors, the method comprising:
applying a basic voltage to the injectors in a closed state;
applying a bottom voltage to open the injectors; and
individually adjusting the bottom voltage for each injector.

9. The method according to claim 8, further comprising determining the bottom voltage for each injector from an average value of the bottom voltage and an individual correction value specific to the injector.

10. The method according to claim 9, wherein the correction value includes a correction factor, and the bottom voltage for each injector is determined from the average value of the bottom voltage multiplied by the correction factor.

11. The method according to claim 9, wherein the correction value includes an offset, and the bottom voltage for each injector is determined from the average value of the bottom voltage to which the offset is added.

12. The method according to claim 9, wherein the correction value is specific to an operating point.

13. A computer-readable medium containing a computer program which when executed by a processor performs the following method for operating an injection system of an internal combustion engine having piezoelectrically triggered injectors:
applying a basic voltage to the injectors in a closed state;
applying a bottom voltage to open the injectors; and
individually adjusting the bottom voltage for each injector.

14. A control device for operating an injection system of an internal combustion engine having piezoelectrically triggered injectors, comprising:
means for applying a basic voltage to the injectors in a closed state;
means for applying a bottom voltage to open the injectors; and
means for individually adjusting the bottom voltage for each injector.
